(19) United States
(12) Patent Application Publication
(10) Pub. No.: US 2010/0186273 A1
(43) Pub. Date: Jul. 29, 2010

(54) Changeable sign

(76) Inventor: Pauline Jones, Martinez, CA (US)

Correspondence Address: Pauline Jones, 727 Lafayette St., Martinez, CA, 94553, US

(21) Appl. No.: 12/321,926

(22) Filed: Jan. 26, 2009

(51) Int. Cl. G09F 7/00

(52) U.S. Cl. 40/492; 40/446

(57) ABSTRACT

The invention is a changeable sign assembly, to be attached, mounted, or otherwise placed upon a surface for the purpose of displaying one of a plurality of signs. Each different sign may contain a message, instruction, symbol, logo, color, or any customization, upon the displayed sign face. The changeable sign, consisting of a plurality of signs, attached to one another in a single assembly unit, would be such that any single sign in the assembly unit would become viewable for display after having been moved to the display position.

### CROSS-REFERENCE TO RELATED APPLICATION

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention concerns that of a changeable sign assembly which allows one of a multitude of signs to be displayed at any given time.

2. Prior Art

No prior art has been found duplicating or approximating the disclosed invention.

The most relevant prior art is exemplified by the following United States patents:

U.S. Pat. No. 4,171,584, Kaiser et. Al., wherein is described an assembly body, mounted to a desired surface by suctions cups, whereby cards bearing various messages can be inserted into slots formed by the ribs of the mounted body of the assembly.

U.S. Pat. No. 6,347,471, Mirza et. al., discloses a structure that allows replaceable and entirely removable individual signs to be alternately posted behind a protective transparent piece of plastic by placing the sign into the assembly which is attached to a surface by suction cups.

U.S. Pat. No. 4,852,284, Faggiano et. al., discloses a base panel that is mounted to glass, such as a window, with metal strips and magnets. Its composition includes a sliding panel with informational lettering which can be moved to positions which alternately hides and reveals the information available for display.

U.S. Pat. No. 4,485,576 discloses a sliding panel system which displays one of two alternate messages dependant upon the position of the slide panel.

U.S. Pat. No. 6,308,446, Healy et. al., discloses a sign frame and backing whereby various signs can be magnetically attached to the metal backing.

The public domain includes sign boards of felt type material in which pronged letters can be inserted into the backing and arranged to create a spelled out message. Also in the public domain are signs with a white board type surface with a pen attached to, or present with the assembly, which allows messages to be written and erased.

The public domain also includes a changeable sign which hangs from a doorknob. This sign has a wheel with different messages at different locations on the wheel. A single cut-away portion of the sign assembly allows a different message to be displayed in the cut-away section by rotating the wheel to display the desired message. Because of the size constraints associated with a door hanger type of sign assembly (the assembly must be small enough not to come into contact with the door frame) this door hanger sign assembly is narrow (about three to four inches). This limits the diameter of the wheel with the various display messages, allowing for a small printed message that requires the reader of the message to be within a few feet of the sign to read. The only embodiment of this sign found was for girls bedrooms with optional display messages such as, “Doing Homework”, “No Boys Allowed”, and others applicable to the market of relatively young girls.

The above is not exhaustive in its detail, as an exhaustive description of prior art is not required for a provisional patent application. A patent search has been performed through the United States Patent Office and in the public domain. Thus, the above detailed prior art references are exemplary of existing prior art. The above cited patents constitute novel improvements to technologies similar to them, as well as patents that have been improved upon.

### SUMMARY OF INVENTION

The invention is a changeable sign assembly, to be attached, mounted, or otherwise placed upon a surface for the purpose of displaying one of a plurality of signs. Each different sign may contain a message, instruction, symbol, logo, color, or any customization, upon the displayed sign face. The changeable sign, consisting of a plurality of signs, attached to one another in a single assembly unit, would be such that any single sign in the assembly unit would become viewable for display after having been moved to the display position.

Though the sign might be used to display a variety of messages for any purpose, in any setting, it could, for example, be attached to the outside of a door, in close proximity to a door, or on a cubical or near its entrance, or area entrance, or within an area, for the purpose of indicating the status of the building, wing, section, room, area, or applicable place, or that of a person or persons within such an area, or to indicate conditions within such an area beyond the display point of the changeable sign assembly. Such a sign, with changeable sign faces, could be ideal in any setting, including, but not limited to, offices or office cubicles, patient exam rooms in a medical setting, home offices, conference rooms, classrooms, rooms being utilized for a purpose for which they may not always or usually be so utilized, and the like.

The scope of the invention would not be limited to the above examples, rather the above detailed examples serve to readily illustrate the utility of a changeable sign in a multitude of environments.

### DRAWINGS

### Preferred Embodiment Drawings

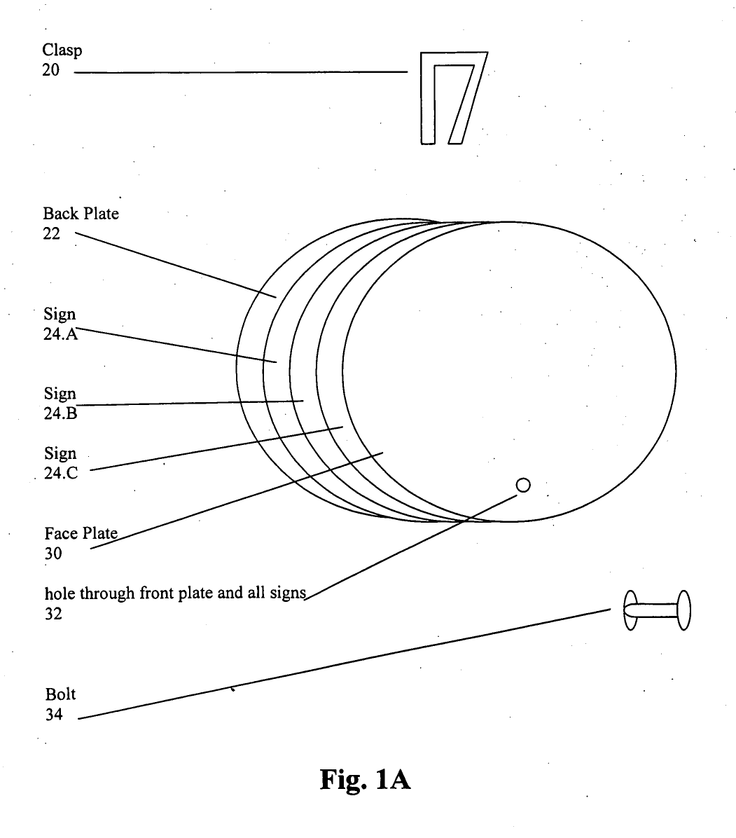

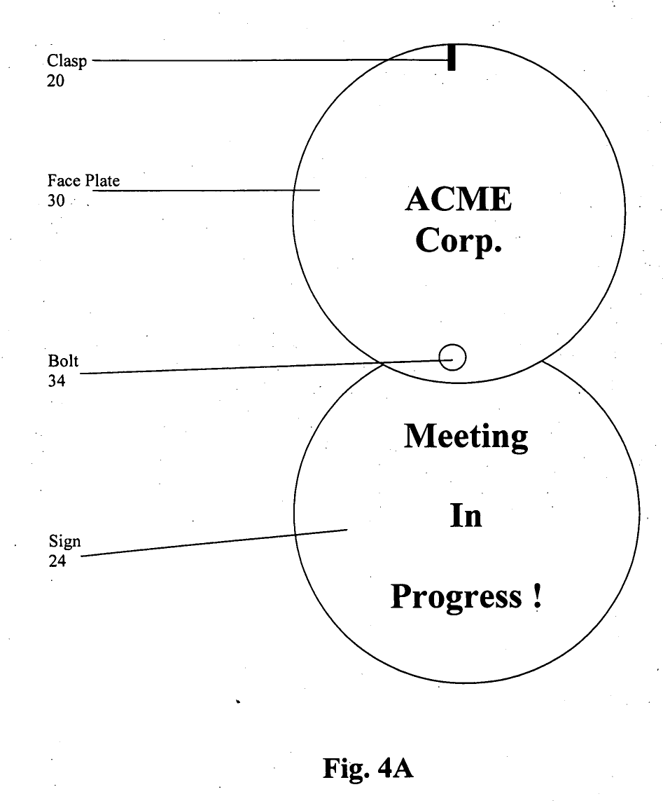

Page 1 of 3 of the preferred embodiment drawings shows an exploded view of the Changeable Sign Assembly and contains three distinct figures; FIGS. 1A, 2A, and 3A.

Page 2 of 3 of the preferred embodiment drawings shows the Changeable Sign Assembly from a frontal view with a sign in the display position. One figure is shown on this page; FIG. 4A.

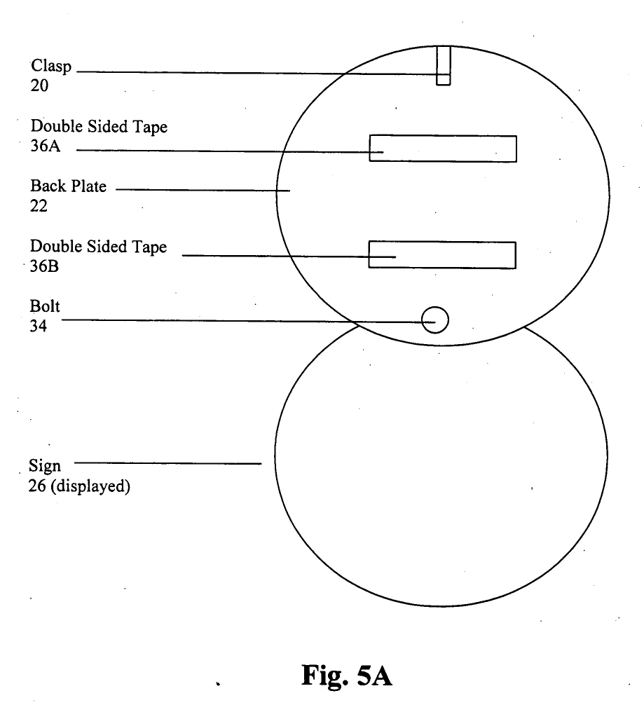

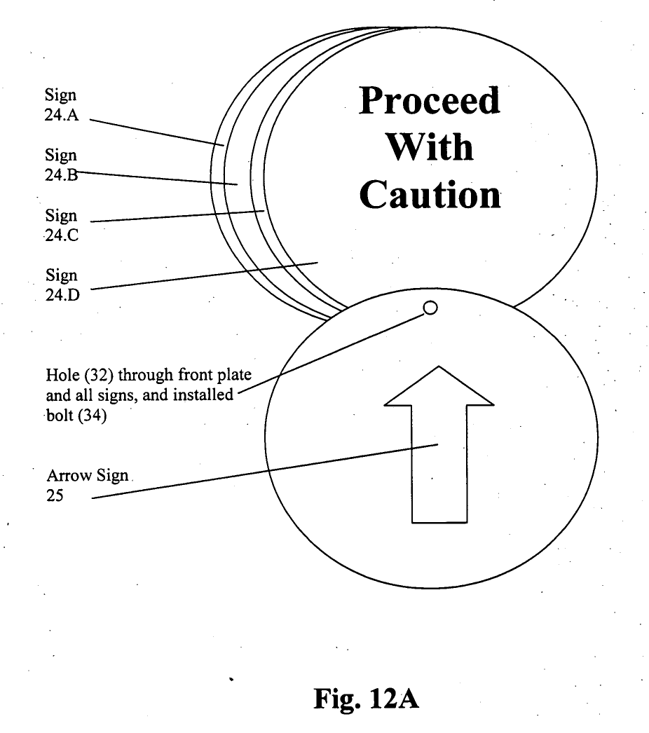

Page 3 of 3 of the preferred embodiment drawings shows the Changeable Sign Assembly from a rear view perspective with one sign in the display position. One figure is shown on this page; FIG. 5A.

### Alternate Embodiment Drawings

Only one of the several alternate embodiments described herein is shown in drawings. The alternate embodiment depicted is referred to as the “Constant Display Embodiment”.

Page 1 of 3 of the alternate embodiment drawings shows an exploded view of the constant display embodiment. This page contains two figures; 12A and 13A.

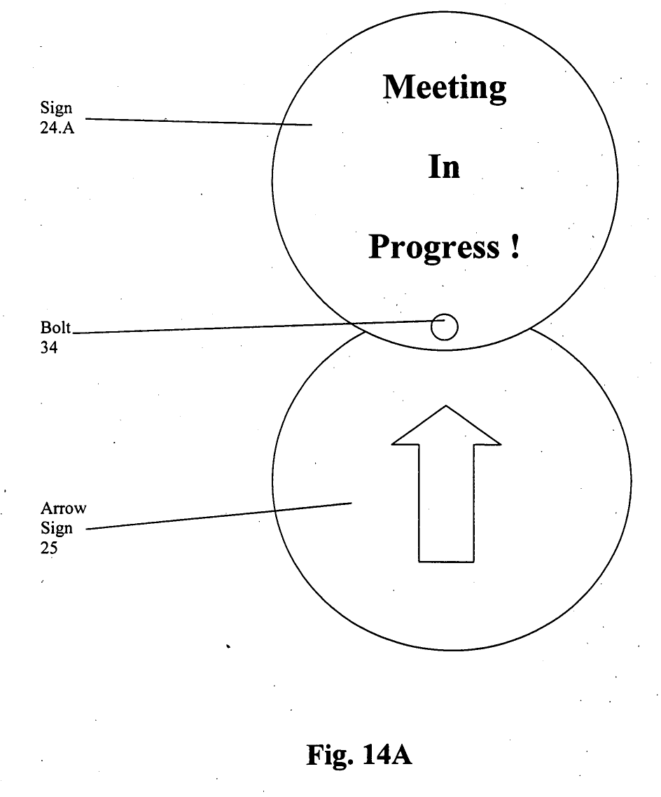

Page 2 of 3 of the alternate embodiment drawings shows a frontal view of the constant display embodiment and contains one figure; FIG. 14A.

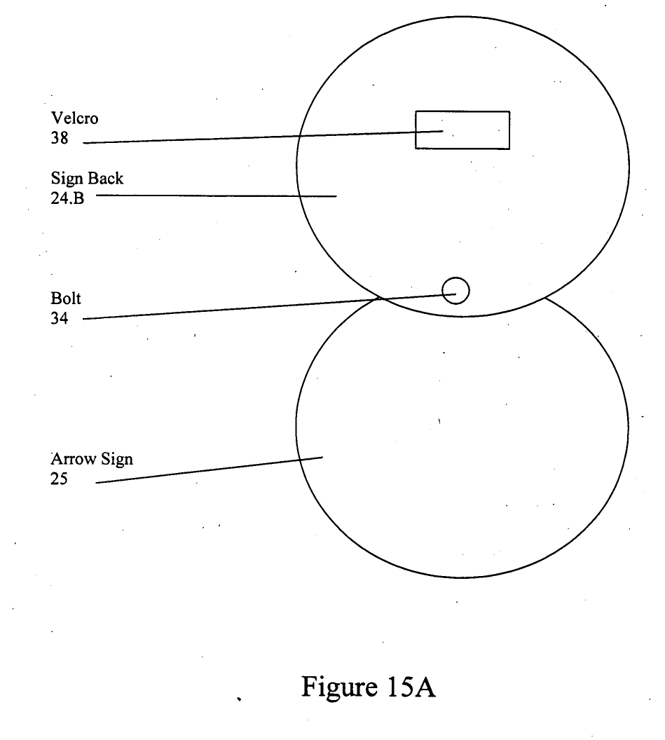

Page 3 of 3 of the alternate embodiment drawings shows back view of the constant display embodiment and contains one figure; FIG. 15A.

### DETAILED DESCRIPTION

The changeable sign assembly would consist of a backing, (henceforth referred to as a back plate) (22), which would ideally be constructed either of a laminated paper or cardboard type of material.

Upon the back of the back plate would be an adhesive, or Velcro, or double sided tape (24).

The assembly would also consist of a face plate (30) constructed either of a laminated paper or cardboard type of material.

The Changeable Sign Assembly includes a clasp (20) which would be affixed to the back plate (22) which would hold in place the plurality of signs (24), as well as the face plate (30), uniformly, over the back plate (22) so that all that is readily visible from a direct frontal view is the face plate (30). The clasp (20), affixed to the back plate (22), for the purpose of keeping all but the displayed sign in uniformity and covered by the face plate (30), would be shaped in a configuration which would hold the sign faces (24 A-C) not being displayed, as well as the face plate (30) covering the sign faces (24 A-C) not being displayed, in place over the back plate (22). The clasp (20) would be configured in the form of a U type of shape, but having the property that the top ends of the U would incline towards one another in order to pinch the plurality of signs (24 A-C) and the face plate (30) together against the back plate (22), and thereby function as a clasp. One side of the clasp (20) would be permanently affixed to the back plate (22) while the other end would pinch and thereby hold, the face plate (30), but not be attached to the face plate (30).

The invention would typically and generally have three or more alternate sign faces (24 A-C), each face bearing a different messages, symbol, indicia, or combination thereof.

The face plate (30), the plurality of signs (24 A-C), and the back plate (22) would be connected to each other, as observed from a frontal view, in the following order; face plate (30), plurality of signs (24 A-C), and back plate (22).

These distinct parts of the invention would be connected in this order by a round implement, such as a bolt (34), rod, pin, or other such implement which would yield a similar functionality. This bolt (34) would be flared out at the ends so as to securely hold the assembly together while simultaneously allowing the plurality of signs (24 A-C) to swing downward into the display position, and alternately, back upward, into the non display position behind the face plate (30). The face plate (30) would also be free to swivel on the bolt (34).

From the perspective of a mounted changeable sign assembly, the bolt (34) attaching the face plate (30), the plurality of signs (24 A-C), and the back plate (22), all to each other, would be at the center bottom most portion of the assembly, one flared end against the front of the face plate (30), and the other flared end against the back of the back plate (22), in order to keep either the front plate (30) or the back plate (22) from being able to detach from one another or from the plurality of signs (24 A-C) between them.

The changeable sign assembly would be manufacturable in a variety of sizes, shapes, and colors. Rounder shapes would yield the greatest functionality within the sign assembly as described in the preferred embodiment. Such rounded shapes would include but not be limited to those that are circular, hexagonal, octagonal, and like.

The size of the changeable sign assembly could vary greatly, just as there are generally a multitude of sign sizes now in the public domain, be they name plates, window signs, or billboards. All come in a variety of sizes.

### Operation of Invention

The changeable sign would contain a plurality of signs within a single assembly, which would be manually changeable to show different sign faces, thereby showing a different message or other indicator, as desired. The Changeable sign assembly would be designed to be attached to or placed upon, or mounted upon a surface, for the purpose of displaying one of a plurality of the available signs in the changeable sign assembly. The changeable sign, consisting of a plurality of signs, attached to one another in a single assembly unit, would be such that any single sign in the assembly unit would become viewable for display after having been moved to the display position.

Such a sign could have a multitude of uses; such as that of indicating the status of a building, wing, section, room, area, or that of a person or persons within such an area, or conditions or events beyond the point or within the area of the sign being displayed. The display of a specific message upon a sign face, would allow others to make appropriate decisions about entering a building, wing, section, room, area, or about making contact with a person or persons within such an area, in response to the message on the displayed sign face. The use of such a changeable sign, would serve to result in more productive work Environments, and could also result in a more efficient use of spatial resources. The changeable sign assembly could also be utilized to increase privacy, safety, or awareness of events.

In an office setting, for example, a sign face could be displayed bearing a message indicated that the person within is not to be disturbed. Conversely, it could be the case that the person working in the office or area simply prefers to work with the door closed, but does not mind colleagues coming in if they need to, and thus a sign face could be displayed indicating this. Alternately, a sign face bearing a message could be displayed to alert others who might be inclined to enter the office, that the person within is only to be disturbed regarding matters of importance. Another sign face could be displayed to indicate that the person is gone for the day and yet another sign face could indicate the occupant of the office to be at lunch, or in another part of the building.

In the case of a medical environment, a sign face with a message displayed indicating that a patient is waiting to see the doctor, or a sign face displaying a message indicating that a patient is ready for discharge, or a sign face indicating that house keeping needs to clean the room, could alternately be displayed. Such a changeable sign assembly would serve to facilitate more efficient patient care and medical office or hospital operations.

To utilize the changeable sign assembly; the entire assembly would be mounted to or placed upon the desired vertical surface, such as a door or wall. The back plate of the changeable sign assembly is the portion of the assembly which would be mounted, attached, or otherwise affixed to the desired surface upon which it is to be displayed.

The back plate would be attached to the door, wall, or other surface in reasonable proximity to the entrance of the area for which it is to be used or within the applicable area. Such attachment would ideally be facilitated by an adhesive, or Velcro, or double sided tape. For a cubicle or similar vertical surface, Velcro could also be used. Also for a cubicle or similar surface, a sharp pin type adhesion system, attached to the back plate, or attachable to the back plate, could be used to mount the changeable sign assembly.

Such a pin type adhesion system would facilitate attachment in a similar way to that of a thumbtack attaching an item to a surface such as that which a cubicle wall is likely to be constructed from.

In the case of a low wall such as that of a cubicle, by a hooking mechanism could be affixed to the back plate to allow the changeable sign assembly to hang from the top of such a wall or other applicable surface by the hook.

With no signs being displayed the Changeable Sign Assembly would be in the “storage position”. The face plate would be covering the sign in the front most position within the assembly of the plurality of signs not being displayed. Thus, the purpose of the face plate would be to cover the signs not in the display position to prevent them from being viewed. The face plate may have indicia upon it such as would be appropriate to the environment in which the changeable sign assembly is being used; such as a company name, other verbiage, a symbol, logo, picture, or may be blank, bearing no indicia.

To use the Changeable Sign Assembly, the face plate would be released from the clasp which is permanently affixed to the back plate and serving to hold the face plate and the plurality of signs uniformly in place. Upon releasing the face plate, the bolt located at the bottom center of the assembly, would then allow the face plate to swing to either side, thus allowing the plurality of displayable signs contained within the assembly between the face plate and the back plate, to become visible and accessible.

At this point, the sign desired to be displayed can be swung downward so that the sign hangs from the bolt and below the rest of the assembly. A sign, thus hanging below the balance of the Changeable Sign Assembly, is now in the “display position”. The face plate and plurality of signs not to be displayed, would then be uniformly placed and secured against the back plate underneath the clasp. These un-displayed signs, held in place by the clasp in uniformity with the back plate and face plate, above the displayed sign, would be in the “storage” position. The position of the displayed sign would now be below the rest of the entire changeable sign assembly. The bolt would be through the top of the displayed sign and the bottom of the face plate and the plurality of signs in the storage position beneath the face plate and over the back plate. If the front plate, the back plate, and the plurality of signs were round in their manufactured shape, the entire assembly, prior to display of a sign, would have an “O” shape. With a sign in the display position, the assembly would take on an “8” shape. The displayed sign could be repositioned in the top portion of the assembly and another sign lowered for display at will.

### PREFERRED EMBODIMENT

The preferred embodiment, would, at this time, consist of a back plate, a plurality of signs, and a face plate, all constructed of a laminated paper product. A clasp, mounted to the back plate, and serving to hold the face plate and the plurality of signs to the back plate by pinching them against the back plate, would be made of a plastic material and permanently attached to the back plate with an adhesive substance.

The bolt which permanently holds the face plate, the plurality of signs, and the back plate together in a single assembly unit and which also allows the display sign to swing downward and into the display position, and back upward into the storage position, would be made of a small metallic rivet or a cotter pin.

The changeable sign assembly, in its initial manufacturing, would be offered with multiple options for affixing it to the desired surface upon which it is to be displayed. These options would include double tape, a hook and Velcro, one side of which would be adhered to the desired surface and the other side to the back plate of the sign assembly, making the sign removable so that it could be utilized at a different location, if so desired.

The preferred embodiment would be constructed so that the front plate, the plurality of signs, and the back plate would be in a round configuration.

The preferred embodiment would utilize a size which would allow indicia to be present upon the plurality of signs which could be easily seen and read from across an office. To facilitate easy reading from a variety of distances, the size of the preferred embodiment of a rounded sign would measure in a range between four to eight inches in diameter.

### ALTERNATIVE EMBODIMENTS

The face plate, the back plate, and the plurality of signs, could be made from a non-laminated paper product, or from photographic paper, plastic, metal, a fiber glass composition, any other material or composition yielding reasonable rigidity and durability, including wood. Any materials with relative hardness and rigidity would yield the same result in essentially the same manner, as the invention disclosed.

The back plate of the assembly unit could be mounted to a wall or other surface with Velcro, double sided tape, suction cups, a permanent or non permanent adhesive, screws, nails, prongs, magnets, or any other method by which items are commonly attached to items or surfaces other than themselves, for the purpose of temporary or permanent attachment, without altering the functionality or utility of the invention.

The entire sign could be placed, attached to, or hung from a separate mounting or hung from or placed upon a stand which allows the sign to be set on a desk but readily visible resulting from its upright position by resultant from such a stand or similar device.

The invention could be constructed in a multitude of common or uncommon shapes without changing the utility, functionality or novelty of the invention. Virtually any shape would work to carry out the invention including that of symbols, cartoon characters, animal shapes, or virtually any geometric shape. Such shapes could readily constitute a changeable sign assembly without contributing to the art in any significant manner.

The invention could be produced and utilized in virtually any size, ranging from a small and difficult to read size, to an oversized configuration that dominates the surface on which it is affixed or placed.

The invention could be comprised of a plurality of changeable signs, the messages on the signs having any message, symbol, picture, logo, indicia or the like. It could be written all languages and in Braille. Signs could be in different colors such as traffic light colors to indicate a status.

The bolt, located at the bottom center of the assembly, used to hold the face plate, the plurality of signs, and the back plate together, and which also allows the face plate and plurality of signs to swing into the display position, could be made of anything round or nearly round and could be constructed of virtually any composition including metal or plastic. The bolt could have an irregular shape such as a square or octagon that facilitates holding the plurality of signs and face plate to the back plate instead of using a clasp.

The clasp that is attached to the back plate and holds the plurality of signs and the face plate in place against the back plate, could be constructed from any rigid material. It could be a clasp of any size. It could be attached to the wall or other like surface without a back plate present in the assembly at all, and thus replace the function of the back plate. This would not be an optimal replacement of the back plate because the changeable sign assembly of such an alternate embodiment would not have all parts permanently attached to one another since the clasp, without a back plate, would not be attachable to the other parts of the assembly except by clasping them, which, when not clasping the face plate and plurality of signs, and with no back plate, would not then be attached to those components of the assembly in any way.

The clasp could be replaced entirely with the addition of one or more strips of Velcro on the back of each sign face, corresponding to Velcro on the front of the sign face that a given sign face would be in front of, when these signs are in the non display position or storage, position. This would hold the sign faces to one another in uniformity in the storage position. The Velcro would be disengaged from the sign face in front and/or behind, the desired sign face, to free it so that it can be swiveled into the display position. Each sign face could have a tab, offset from the tabs of the other signs, which could make it easier and faster to select the desired sign and move it into the display position.

A design could be achieved in which the display position is achieved by bringing a sign up to a display position. In such a case, there would be no need for a back plate. In this design, the sign being displayed would be at the top of the assembly when the sign to be displayed is in the display position. The sign in the display position would have Velcro or another method of adhesion to a surface upon the back of it. The sign to be displayed would be lifted from the assembly, adhered to the vertical surface, and the face plate, along with the plurality of signs being covered by the face plate, would hang below the sign that is in the display position. In such a design, the bolt or other implement holding the design assembly permanently together and allowing the plurality of signs and the face plate to swivel, would be in the top of the assembly in the storage position and the bottom of the sign in the display position.

An embodiment could be achieved also where the sign would be brought up for display, instead of down as in the primary embodiment and if no clasp were used a sign would always be in the display position and what was the face plate in other embodiments could show an arrow indication the area to which the sign pertains. This we call the Constant Display embodiment.

In any embodiment where a clasp is used to hold the plurality of signs in place, the clasp that is attached to the back plate and holds the plurality of signs and the face plate in place against the back plate, could be replaced with significant dimpling in the back plate, the plurality of signs, and the face plate. In this embodiment, if we were viewing the changeable sign assembly from a mounted position, the dimpling would be from the back of the changeable sign assembly unit forward, with a male type outward protruding portion of the dimple in the front face of the back plate, the front face of the plurality of signs, and the front face of the face plate. The outward protruding portion of the dimple would fit into the back, inward side of the dimple in the sign or face plate in front of it. With the face plate, the plurality of signs, and the back plate bound tightly by the bolt implement located in the bottom center of the aforementioned components, this type of dimpling would hold the plurality of signs in place, as well as the front plate. This embodiment would yield the same functionality as that resulting from the clasp described in the preferred embodiment section above.

### CONCLUSION

The Changeable Sign Assembly allows one of a plurality of signs to be displayed by moving the desired sign into the display position. Such a sign is, in both form and function, unparalleled in the prior art. Neither is there anything disclosed in the prior art that has a plurality of signs, permanently attached to one another in an assembly unit, with the function that any one particular sign is displayable by swinging that sign below or above the rest of the assembly, thereby making it visible, while the plurality of signs not to be displayed are left hidden behind a face plate. There is no other sign or sign assembly, manually operable, with the utility of being able to hold numerous different signs within a single assembly which is so simple both to produce and to operate.

1. A changeable sign assembly comprising a plurality of signs, any one of which can be moved to a position by which it is unobstructed from the assembly and thereby displayed.

2. A changeable sign assembly, as described in claim one above, the signs within the assembly held in place by a cylindrical implement which allows the individual signs to swivel 360 degrees around the cylindrical implement, thus permitting a any sign within the assembly to be placed in different positions in relation to the rest of the assembly.

3. A changeable sign assembly, as described in claims one and two above, with a stationary front plate or back plate and two or more signs within the assembly which may be moved to a different position relative to the front plate or back plate, so that one or more signs may become visible and thereby displayed.
